(19) United States
(12) Patent Application Publication
(10) Pub. No.: US 2001/0041263 A1
(43) Pub. Date: Nov. 15, 2001

(54) Ultraviolet absorbing products

(76) Inventor: Norman M. Sweet, Waterford Township, MI (US)

Correspondence Address: Ronald W. Citkowski, Gifford, Krass, Groh, Sprinkle, Anderson & Citkowski, P.C., 280 N. Old Woodward Ave., Suite 400, Birmingham, MI, 48009, US

(21) Appl. No.: 09/755,474

(22) Filed: Jan. 5, 2001

Related U.S. Application Data
(60) Provisional application No. 60/174,869, filed on Jan. 7, 2000.

(51) Int. Cl. B32B 17/08; B32B 23/20

(52) U.S. Cl. 428/439; 428/438

(57) ABSTRACT

An ultraviolet absorbing protective device includes a matrix material having an ultraviolet absorbing dye disposed therein. The dye is most preferably an azo dye having very high absorption for ultraviolet wavelengths and low absorption for visible wavelengths. In specific embodiments, the protective structure absorbs at least 90% of ultraviolet radiation, in the wavelength range of 250 to 380 nm, incident thereupon. The device transmits at least 80%, and most preferably at least 90%, of visible wavelengths in the range of 500 to 700 nm.

### RELATED APPLICATION

This patent application claims priority of provisional patent application Ser. No. 60/174,869 filed Jan. 7, 2000, entitled “Ultraviolet Absorbing Products.”

### TECHNICAL FIELD

The present invention generally relates to ultraviolet absorbing materials. More particularly, the present invention relates to products useful for shading persons or objects from ultraviolet radiation.

### BACKGROUND OF THE INVENTION

Recently, concern about exposure of humans to ultraviolet light from the sun has gained much attention. In part, the increased attention has been directly related to evidence which indicates that the ozone layer in the earth's upper atmosphere which protects or shields the surface of the earth from much of the sun's harmful ultraviolet radiation is being depleted. It has been speculated that this decrease in the ozone layer will lead to a large increase in the number of individuals developing skin cancers. Additionally, ultraviolet radiation is thought to be harmful because of its genotoxic, mutagenic, carcinogenic, and immunotoxic properties. It is also known that increased exposure to ultraviolet light can cause damage to the eyes in the form of cataracts and can also cause a general degradation or premature aging of the skin.

In response to these findings, health officials are advising people to protect themselves, especially children, from prolonged exposure to the sun.

In addition to causing harm to living organisms such as human beings, ultraviolet radiation or light can also cause damage and/or degradation to inanimate objects. For example, it is well known that ultraviolet exposure of carpets and fabrics can cause their premature fading. Ultraviolet exposure of certain plastics can cause the plastics to prematurely age and/or weaken.

Accordingly, it would be advantageous and desirable to have a product which can effectively and easily shield a person or an object from the harmful effects of ultraviolet radiation. Furthermore, it would be advantageous if such shielding member were reasonably transparent at visible wavelengths.

### BRIEF DESCRIPTION OF THE INVENTION

There is disclosed herein an ultraviolet absorbing, protective device. The device is comprised of a matrix member having a dye disposed therein. The dye is most preferably an ultraviolet absorbing azo dye. Most preferably, the dye is from a specific group of azo dyes disclosed herein which have very high absorptions in ultraviolet wavelengths, and low absorptions in visible wavelengths. In particularly preferred embodiments of the invention, the protective device of the present invention will absorb at least 90% of radiation incident thereupon having a wavelength in the range of 250 to 380 nm, while transmitting at least 80%, and most preferably 90%, of radiation incident thereupon having a wavelength in the range of 500 to 700 nm.

### BRIEF DESCRIPTION OF THE DRAWINGS

FIG. 1 is a schematic depiction of the protective device of the present invention as disposed upon a window of a house and upon a window of an automobile.

FIG. 2 is a schematic depiction of a self-supporting, ultraviolet absorbing, protective structure configured in accord with the principles of the present invention.

### DETAILED DESCRIPTION OF THE INVENTION

The present invention generally provides an ultraviolet absorbing film or layer which can be disposed between a user or an object and the source of ultraviolet radiation, typically the sun. The film or layer of the present invention provides nearly complete protection from ultraviolet rays and is capable of blocking up to 99.9% of the ultraviolet light contained in sunlight, yet is visually transparent. The film of the present invention is in contrast to previously employed ultraviolet absorbing films, which are highly absorbing in the visible portions of the spectrum.

The film or layer of the present invention preferably comprises an ultraviolet absorbing dye dissolved in a polymer matrix material. The film or layer preferably has a thickness which is generally in the range of 1 to 10 microns. Preferably, the protective device of the present invention will absorb at least 90% of incident radiation in the range of 250 to 380 nm, while transmitting at least 80%, and most preferably 90% or more, of wavelengths in the range of 500 to 700 nm. The film or layer can be freestanding or it can be disposed and/or affixed to a substrate or support layer which can be comprised of polyester material such as polyethylene terepthalate (PET). Other substrates can comprise rigid polymers, glass and the like.

There are a number of ultraviolet absorbing dyes known and available to those of skill in the art, which may be employed in the practice of the present invention. However, the present invention preferably employs a unique class of ultraviolet absorbing dyes which have very high absorptions for ultraviolet light but which are relatively transparent to visible wavelengths and infrared wavelengths. In addition, these dyes are very stable under high levels of illumination, and also have very good thermal stability and good stability to ambient atmospheric conditions. This preferred group of dyes comprises azo dyes.

As is known in the art, azo dyes can be formed by the coupling of a diazonium salt with another organic molecule, typically an aromatic molecule. One particular diazonium salt which may be employed to form azo dyes having utility in the present invention is represented by Formula I hereinbelow:

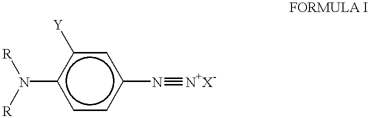

Another diazonium salt having utility in the practice of the present invention is defined by Formula II hereinbelow:

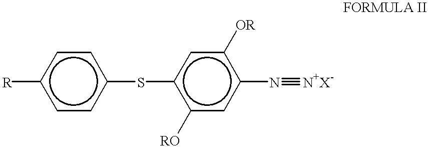

In both instances, R equals hydrogen or an alkyl group, most preferably methyl, ethyl, or propyl; Y is a halogen, preferably chlorine or fluorine; and X may be any anion, and most typically comprises a halogen, NO₃⁻, HSO₄⁻, BF₄⁻, PF₆⁻, and the like.

The coupler molecule which reacts with the diazonium salt to form the diazo dye is preferably an aromatic molecule. Some particularly preferred couplers are represented by Formulas III and IV hereinbelow:

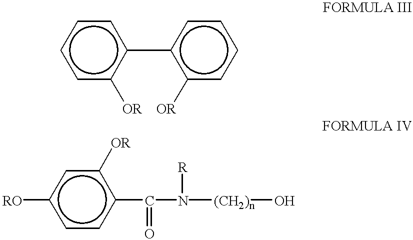

In the foregoing, R is hydrogen or alkyl as above, and for these particular couplers R is most preferably hydrogen or a low molecular weight alkyl; n is 0 or a whole number, and is most preferably 1, 2 or 3.

Azo dyes made in accord with the foregoing structural formulas are easily synthesized, stable on storage, highly absorbing of ultraviolet wavelengths, and relatively poor absorbers of visible and near infrared wavelengths. Some particular dyes which may be utilized in the present invention will be described hereinbelow, but it is to be understood that such examples are illustrative of the present invention, and not limitations upon the practice thereof.

A first dye having utility in the present invention is prepared from a diazonium salt of the general Formula I herein above, in which the halogen, Y, is chlorine and both R groups are ethyl. The cation of this salt may be referred to as p-diazonium-o-chloro-N, N-diethylaniline. Reaction of this ion with a coupler of the general Formula III in which both R groups are hydrogen (2, 2 -dihydroxy-biphenyl), couples the diazonium nitrogen to one of the aromatic rings to liberate HX and form the resultant azo dye. The resultant dye has a pale yellow color to the eye and a high absorption in the ultraviolet portions of the spectrum, typically below 360 nanometers.

If the coupling reaction is carried out with a coupler of the general Formula IV in which both Rs are hydrogen and n is 2 (beta-resorcylic acid-thanolamide), the resultant dye will have a brownish color to the eye, and will be primarily absorbing of light in the visible portions of the spectrum.

Another group of compounds were prepared by reacting a diazonium salt of the type represented by Formula I in which both of the R groups are methyl, with the aforedescribed couplers. The resultant diazo dyes were generally similar to those obtained through the use of the diethyl compound.

Another group of diazo dyes were prepared from a diazonium salt of the type represented by Formula II, in which the R group para to the sulfur is methyl and the remaining R groups which are attached to the oxygens, are both ethyl. The corresponding cation may be referred to as 1-diazonium-2, 5-diethoxy-4-tolylmercapto-benzene. Coupling of this diazonium ion with either of the aforedescribed couplers produces an azo dye having a high absorption in the ultraviolet portions of the spectrun.

The dyes are disposed in a polymeric matrix. While it is possible to react the diazonium salt with the coupler in the matrix to form the dye in situ, it is generally preferable to preform the dye in a separate synthesis step, and then incorporate that dye into the matrix. There are a variety of matrix materials which may be employed in the present invention. A matrix material should be compatible with the dye, have good adhesion to the underlying first layer of the material and should also be relatively transparent to visible, near ultraviolet and near infrared wavelengths. One particularly preferred group of matrix materials comprises cellulose acetate polymers with cellulose acetate propionate (CAP) being a particularly preferred material. CAP has good film forming properties, good broad spectrum transparency, and adheres very well to other materials. Other polymers such as cellulose acetate butyrate (CAB), cellulose acetate and vinyl materials may be similarly employed.

In one particularly preferred embodiment of the present invention, the polymer for the second layer comprises a mixture of two different viscosities of CAP, with the first material comprising a relatively low viscosity polymer and the second a higher viscosity polymer. As is known in the art, viscosity of polymers is often quantified by noting the time it takes for a given amount of a standard solution of a polymer to pass through a standard size opening in a container. One preferred mix of resins comprises a 0.5 second resin and a 20 second resin used in equal weight amounts and such resins are available from the Eastman Chemical Company under the designation CAP 504-0.2 and CAP 482-20.

The first layer of the material should include sufficient ultraviolet dye to give it a fairly high optical density in the ultraviolet portion of the spectrum, while avoiding undue absorption in the infrared and visible portions of the spectrum. Typical loadings of dye comprise approximately 10-100 milligrams of dye per cm². Coating of the second layer is typically accomplished by extrusion coating from a solvent based solution of polymer and dye; although, other coating techniques such as rod coating, spin coating, blade coating, dip coating and the like may be employed.

Additionally, the UV absorbing film or layer can be fabricated by using methods and materials as described in U.S. Ser. No. 09/229,182 and U.S. Pat. No. 5,747,197, both of which are incorporated herein by reference.

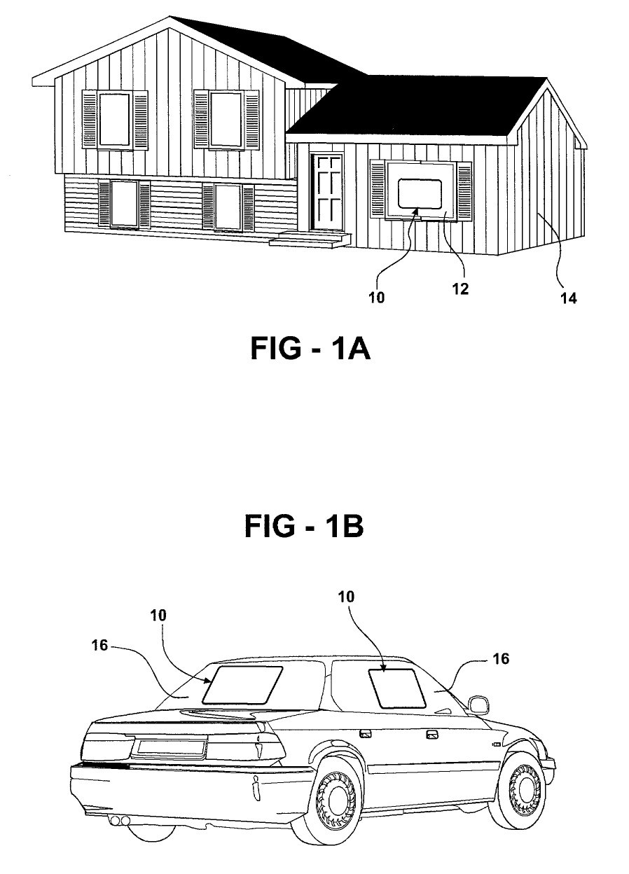

The UV blocking film or layer of the present invention can be provided in any suitable form. Referring to FIG. 1, the UV blocking film or layer 10 is provided in the form of a sheet which can be either permanently or temporarily affixed to a transparent surface such as a window 12. Unlike normal “window” film that can lose its ultraviolet blocking ability over time and is therefore never permanent, the ultraviolet blocking film or layer 10 of the present invention permanently retains its ability to block ultraviolet light, thus permitting reuse. Additionally, the UV blocking film can be moved from one transparent surface, such as a window, to another. For example, the UV blocking film or layer 10 of the present invention can be affixed to a home 12 or automobile 16 window in order to prevent the transmission of ultraviolet light therethrough.

The ultraviolet film or layer 10 of the present invention can be affixed by any suitable means including static electricity and/or an adhesive such as a repositionable adhesive which is well known in the art.

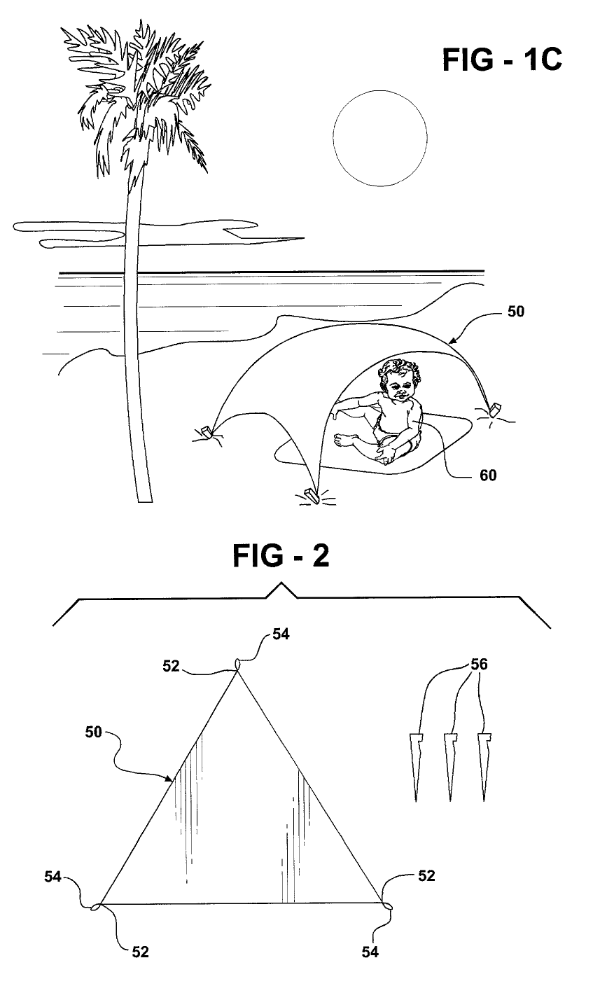

Additionally, referring to FIG. 2, the ultraviolet absorbing film or layer can be provided in the form of a sun shield structure, as is shown at 50. In this embodiment, the ultraviolet absorbing film or layer 50 is provided in an essentially triangular form having loops 54 or other suitable attachment means disposed at each vertex 52 of the triangle. The attachment means 54 can then be affixed into the ground, for example, utilizing staking devices 56 similar to tent stakes. Utilizing this shape, an air foil-shaped structure can be formed wherein the objects, such as an infant 60, can be shielded thereunder from the ultraviolet rays of the sun. Additionally, the edges of the film can be protected utilizing resilient materials or sleeves, such as rubber, to protect the user from any sharp edges. In this embodiment, a relatively gentle breeze will keep the air-foil structure inflated so as to be self-supporting. In other embodiments, the edges may be made from a relatively rigid resilient material such as a polymer, so as to provide a self-supporting structure.

In view of the teaching presented herein, other modifications and variations of the present invention will readily be apparent to those of skill in the art. The discussion and description are illustrative of some embodiments of the present invention, but are not meant to be limitations on the practice thereof. It is the following claims, including all equivalents, which define the scope of the invention.

1. An ultraviolet absorbing, protective device comprising a matrix member having an azo dye therein, wherein said azo dye is formed by the reaction of an aromatic coupling agent with a diazonium salt selected from the group consisting of: 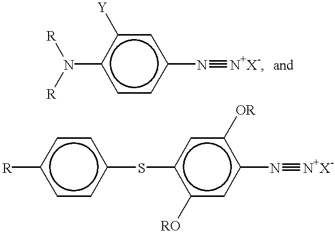
wherein R is hydrogen or an alkyl, Y is a halogen and X is an anion.

2. The ultraviolet absorbing, protective device of claim 1, wherein said aromatic compound is selected from the group consisting of: 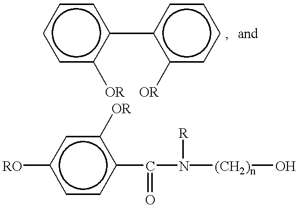
wherein R is hydrogen or an alkyl and n is 0 or a positive integer.

3. The ultraviolet absorbing, protective device of claim 1, wherein said matrix member comprises a layer of polymeric material, and wherein said azo dye is dissolved therein.

4. The ultraviolet absorbing, protective device of claim 3, wherein said layer of polymeric material comprises a cellulose acetate polymer.

5. The ultraviolet absorbing, protective device of claim 1, wherein the amount of azo dye in said matrix is in the range of 10-100 mg of dye per cm² of said device.

6. An ultraviolet absorbing, protective device comprising a matrix member having an ultraviolet absorbing dye therein, said device characterized in that it will absorb at least 90% of radiation incident thereupon having a wavelength in the range of 250 to 380 nm, and that it will transmit at least 80% of radiation incident thereupon having a wavelength in the range of 500 to 700 nm.

7. The device of claim 6, further characterized in that it will transmit at least 90% of radiation incident thereupon having said wavelength in the range of 500 to 700 nm.
